(19) United States
(12) Patent Application Publication
(10) Pub. No.: US 2025/0131756 A1
(43) Pub. Date: Apr. 24, 2025

(54) TEXT RECOGNITION METHOD AND APPARATUS, STORAGE MEDIUM AND ELECTRONIC DEVICE

(71) Applicant: BOE TECHNOLOGY GROUP CO., LTD., Beijing (CN)

(72) Inventors: Guangwei HUANG, Beijing (CN); Fengshuo HU, Beijing (CN); Yanjiao WANG, Beijing (CN); Dan WANG, Beijing (CN); Xiaoyan HAN, Beijing (CN); Peihuan YANG, Beijing (CN); Fanhao KONG, Beijing (CN)

(73) Assignee: BOE TECHNOLOGY GROUP CO., LTD., Beijing (CN)

(21) Appl. No.: 18/695,718

(22) PCT Filed: Nov. 23, 2021
(86) PCT No.: PCT/CN2021/132502

§ 371 Date: Mar. 26, 2024

(51) Int. Cl. G06V 30/19; G06V 10/82; G06V 30/162

(52) U.S. Cl. CPC G06V 30/19127; G06V 10/82; G06V 30/162; G06V 30/19113; G06V 30/19173

(57) ABSTRACT

The text recognition method includes: acquiring a first high-frequency feature map and a first low-frequency feature map of a target image; performing an M-level convolution process on the first high-frequency feature map and the first low-frequency feature map by M cascaded convolution modules to obtain M pairs of target high-frequency feature map and target low-frequency feature map of the target image, where M is a positive integer; merging the M pairs of target high-frequency feature map and target low-frequency feature map to obtain a target feature map of the target image; determining a probability map and a threshold map of the target image based on the target feature map, and calculating a binarization map of the target image based on the probability map and the threshold map; and determining a text area in the target image based on the binarization map, and recognizing text information in the text area.

### CROSS REFERENCE TO RELATED APPLICATION(S)

The present disclosure is the 35 U.S.C. 371 national phase application of PCT International Application No. PCT/CN2021/132502 filed on Nov. 23, 2021, the entire content of which is incorporated herein by reference for all purposes.

### FIELD

The present disclosure relates to the field of artificial intelligence technology, and in particular, to a text recognition method, a text recognition apparatus, a non-volatile computer-readable storage medium, and an electronic device.

### BACKGROUND

With the rapid development of Internet technology and the rapid popularity of smartphones, people will increasingly use digital cameras, cameras, or mobile phones to take pictures and upload materials (such as bills, vouchers, etc.). However, due to the complex background and many environmental interference factors when taking pictures in natural scenes, it is difficult to distinguish the text in the picture from the background, which poses a great challenge to text detection.

In order to recognize text in natural scene images, experts have designed many Optical Character Recognition (OCR) character recognition systems, which usually have good detection results for text in documents. However, when detecting text in scene images, there is still some room for optimization in terms of recognition efficiency and recognition accuracy.

It should be noted that the information disclosed in the Background section is only used to enhance understanding of the background of the present disclosure, and therefore may include information that does not constitute prior art known to those of ordinary skill in the art.

### SUMMARY

The present disclosure provides a text recognition method, a text recognition apparatus, a non-volatile computer-readable storage medium, and an electronic device, thereby improving the recognition accuracy and recognition efficiency of text recognition at least to a certain extent.

According to an aspect of the present disclosure, a text recognition method is provided, including:
acquiring the first high-frequency feature map and the first low-frequency feature map of the target image;
performing an M-level convolution process on the first high-frequency feature map and the first low-frequency feature map through M cascaded convolution modules to obtain M pairs of target high-frequency feature map and target low-frequency feature map of the target image, where M is a positive integer;
merging the M pairs of target high-frequency feature map and target low-frequency feature map to obtain the target feature map of the target image;
determining the probability map and the threshold map of the target image based on the target feature map, and calculating the binarization map of the target image based on the probability map and the threshold map; and
determining a text area in the target image based on the binarization map, and recognizing the text information in the text area.

In an exemplary embodiment of the present disclosure, the convolution module performs a convolution process on the first high-frequency feature map and the first low-frequency feature map, and the convolution process includes:
performing a first convolution process on the input first high-frequency feature map to obtain a second high-frequency feature map, and performing an up-sampling convolution process on the input first low-frequency feature map to obtain a second low-frequency feature map;
acquiring the target high-frequency feature map based on the second high-frequency feature map and the second low-frequency feature map;
performing a second convolution process on the input first low-frequency feature map to obtain a third low-frequency feature map, and performing a down-sampling convolution process on the input first high-frequency feature map to obtain a third high-frequency feature map; and
acquiring the target low-frequency feature map based on the third low-frequency feature map and the third high-frequency feature map.

In an exemplary embodiment of the present disclosure, the convolution module performs a convolution process on the first high-frequency feature map and the first low-frequency feature map, and the convolution process includes:
performing a first convolution process on the input first high-frequency feature map to obtain a second high-frequency feature map, and performing an up-sampling convolution process on the input first low-frequency feature map to obtain a second low-frequency feature map;
acquiring a third high-frequency feature map based on the second high-frequency feature map and the second low-frequency feature map, and performing a high-frequency feature extraction process on the third high-frequency feature map to obtain a fourth high-frequency feature map;
short-circuiting the first high-frequency feature map to obtain a fifth high-frequency feature map, and acquiring the target high-frequency feature map based on the fourth high-frequency feature map and the fifth high-frequency feature map;
performing a second convolution process on the input first low-frequency feature map to obtain a third low-frequency feature map, and performing a down-sampling convolution process on the input first high-frequency feature map to obtain a sixth high-frequency feature map;
acquiring a fourth low-frequency feature map based on the third low-frequency feature map and the sixth high-frequency feature map, and performing a low-frequency feature extraction process on the fourth low-frequency feature map to obtain a fifth low-frequency feature map; and
short-circuiting the first low-frequency feature map to obtain a sixth low-frequency feature map, and acquiring the target low-frequency feature map based on the fifth low-frequency feature map and the sixth low-frequency feature map.

In an exemplary embodiment of the present disclosure, the high-frequency feature extraction process performed on the third high-frequency feature map includes: performing a third convolution process on the third high-frequency feature map; and the low-frequency feature extraction process performed on the fourth low-frequency feature map includes: performing a fourth convolution process on the fourth low-frequency feature map.

In an exemplary embodiment of the present disclosure, each convolution module includes an attention unit. The method further includes: adjusting the feature weight output by the convolution module through the attention unit.

In an exemplary embodiment of the present disclosure, the adjusting of the feature weight output by the convolution module includes:
encoding each channel of the target high-frequency feature map and the target low-frequency feature map output by the convolution module along the horizontal direction to obtain the first direction perceptual map, and encoding each channel of the target high-frequency feature map and the target low-frequency feature map output by the convolution module along the vertical direction to obtain the second direction perceptual map;
connecting the first directional perceptual map and the second directional perceptual map to obtain a third directional perceptual map, and performing a first convolution transformation process on the third directional perceptual map to obtain an intermediate feature mapping diagram;
dividing the intermediate feature mapping diagram into a first tensor and a second tensor along a spatial dimension, and performing a second convolution transformation process on the first tensor and the second tensor; and
expanding the first tensor and the second tensor after the second convolution transformation process to obtain a target high-frequency feature map with an adjusted feature weight and a target low-frequency feature map with an adjusted feature weight.

In an exemplary embodiment of the present disclosure, the n-th level convolution module is further configured to perform a 2⁽ⁿ⁺¹⁾x down-sampling process on the input first high-frequency feature map and first low-frequency feature map, and the merging of the M pairs of target high-frequency feature map and target low-frequency feature map to obtain the target feature map of the target image includes:
performing a 2⁽ⁿ⁺¹⁾x up-sampling process on the target high-frequency feature map and the target low-frequency feature map output by the attention unit included in the n-th level convolution module; and
merging, in corresponding dimensions, and connecting, in corresponding channel numbers, the M pairs of target high-frequency feature map and target low-frequency feature map after the up-sampling process to obtain the target feature map of the target image.

In an exemplary embodiment of the present disclosure, the determining of the probability map and the threshold map of the target image based on the target feature map, and the calculating of the binarization map of the target image based on the probability map and the threshold map, include:
predicting the probability that each pixel in the target image is text based on the target feature map to obtain the probability map of the target image;
predicting the binary result that each pixel in the target image is text based on the target feature map to obtain the threshold map of the target image; and
performing an adaptive learning process by using a differentiable binarization function in combination with the probability map and the threshold map to obtain the best adaptive threshold, and acquiring the binarization map of the target image based on the best adaptive threshold and the probability map.

In an exemplary embodiment of the present disclosure, the method further includes:
predicting the definition information of the target image based on the target high-frequency feature map and the target low-frequency feature map output by the attention unit included in the M-th level convolution module; and/or
predicting the angle offset information of the target image based on the target high-frequency feature map and the target low-frequency feature map output by the attention unit included in the M-th level convolution module.

In an exemplary embodiment of the present disclosure, the value of M is 4.

In an exemplary embodiment of the present disclosure, the method further includes: predicting the language in which the target image contains text based on the target feature map;

The recognizing of the text information in the text area includes: determining a corresponding text recognition model according to the language in which the target image contains text to recognize the text information in the text area.

According to an aspect of the present disclosure, a text recognition apparatus is provided, including:
a first feature extraction module, configured to acquire the first high-frequency feature map and the first low-frequency feature map of the target image;
a second feature extraction module, configured to perform an M-level convolution process on the first high-frequency feature map and the first low-frequency feature map through M cascaded convolution modules to obtain M pairs of target high-frequency feature map and target low-frequency feature map of the target image, where M is a positive integer;
a feature merging module, configured to merge the M pairs of target high-frequency feature map and target low-frequency feature map to obtain a target feature map of the target image;
a binarization map determination module, configured to determine the probability map and the threshold map of the target image based on the target feature map, and calculate the binarization map of the target image based on the probability map and the threshold map; and
a text recognition module, configured to determine a text area in the target image according to the binarization map, and recognize text information in the text area.

In an exemplary embodiment of the present disclosure, each convolution module includes an attention unit, and the attention unit is configured to adjust the feature weight output by the convolution module.

According to an aspect of the present disclosure, a text recognition system is provided, including:
a first feature extraction module, including a first octave convolution unit, where the first octave convolution unit is configured to acquire the first high-frequency feature map and the first low-frequency feature map of the target image; and
a second feature extraction module, including M cascaded convolution modules, where each convolution module includes:
a second octave convolution unit, configured to perform an octave convolution process based on the input high-frequency feature map and low-frequency feature map to obtain the target high-frequency feature map and the target low-frequency feature map of the target feature map; and
an attention unit, configured to adjust the feature weights of the target high-frequency feature map and the target low-frequency feature map based on the attention mechanism.

The second octave convolution unit of the first level convolution module inputs the first high-frequency feature map and the first low-frequency feature map. The second octave convolution units of the second level to M level convolution units input the target high-frequency feature map and the target low-frequency feature map output by the previous level convolution module.

The text recognition system further includes:
a feature merging module, configured to merge the M pairs of target high-frequency feature map and target low-frequency feature map with adjusted feature weights to obtain the target feature map of the target image;
a binarization map determination module, configured to determine the probability map and the threshold map of the target image based on the target feature map, and calculate the binarization map of the target image based on the probability map and the threshold map; and
a text recognition module, configured to determine a text area in the target image based on the binarization map, and recognize text information in the text area.

In an exemplary embodiment of the present disclosure, the second octave convolution unit is specifically configured to:
perform a first convolution process on the input high-frequency feature map to obtain a second high-frequency feature map, and perform an up-sampling convolution process on the input low-frequency feature map to obtain a second low-frequency feature map;
acquire the target high-frequency feature map based on the second high-frequency feature map and the second low-frequency feature map;
perform a second convolution process on the input low-frequency feature map to obtain a third low-frequency feature map, and perform a down-sampling convolution process on the input high-frequency feature map to obtain a third high-frequency feature map; and
acquire the target low-frequency feature map based on the third low-frequency feature map and the third high-frequency feature map.

In an exemplary embodiment of the present disclosure, the second octave convolution unit is specifically configured to:
perform a first convolution process on the input high-frequency feature map to obtain a second high-frequency feature map, and perform an up-sampling convolution process on the input low-frequency feature map to obtain a second low-frequency feature map;
acquire a third high-frequency feature map based on the second high-frequency feature map and the second low-frequency feature map, and perform a high-frequency feature extraction process on the third high-frequency feature map to obtain a fourth high-frequency feature map;
short-circuit the input high-frequency feature map to obtain a fifth high-frequency feature map, and acquire the target high-frequency feature map based on the fourth high-frequency feature map and the fifth high-frequency feature map;
perform a second convolution process on the input low-frequency feature map to obtain a third low-frequency feature map, and perform a down-sampling convolution process on the input high-frequency feature map to obtain a sixth high-frequency feature map;
acquire a fourth low-frequency feature map based on the third low-frequency feature map and the sixth high-frequency feature map, and perform a low-frequency feature extraction process on the fourth low-frequency feature map to obtain a fifth low-frequency feature map; and
short-circuit the input low-frequency feature map to obtain a sixth low-frequency feature map, and acquire the target low-frequency feature map based on the fifth low-frequency feature map and the sixth low-frequency feature map.

In an exemplary embodiment of the present disclosure, the attention unit is specifically configured to:
encode each channel of the target high-frequency feature map and the target low-frequency feature map along the horizontal direction to obtain a first direction perceptual map, and encode each channel of the target high-frequency feature map and the target low-frequency feature map output by the convolution module along the vertical direction to obtain the second direction perceptual map;
connect the first directional perceptual map and the second directional perceptual map to obtain a third directional perceptual map, and perform a first convolution transformation process on the third directional perceptual map to obtain an intermediate feature mapping diagram;
divide the intermediate feature mapping diagram into a first tensor and a second tensor along a spatial dimension, and perform a second convolution transformation process on the first tensor and the second tensor; and
expand the first tensor and the second tensor after the second convolution transformation process to obtain a target high-frequency feature map with an adjusted feature weight and a target low-frequency feature map with an adjusted feature weight.

In an exemplary embodiment of the present disclosure, the n-th level convolution module is further configured to perform a 2⁽ⁿ⁺¹⁾x down-sampling process on the input first high-frequency feature map and first low-frequency feature map, and the feature merging module is specifically configured to:
perform a 2⁽ⁿ⁺¹⁾x up-sampling process on the target high-frequency feature map and the target low-frequency feature map output by the attention unit included in the n-th level convolution module; and
merge, in corresponding dimensions, and connect, in corresponding channel numbers, the M pairs of target high-frequency feature map and target low-frequency feature map after the up-sampling process to obtain the target feature map of the target image.

According to an aspect of the present disclosure, an electronic device is provided, including: a processor; and a memory, for storing one or more programs. When the one or more programs are executed by the processor, the processor is caused to implement the methods as provided in some aspects of the present disclosure.

According to an aspect of the present disclosure, a computer-readable storage medium is provided, having a computer program stored thereon. When the computer program is executed by a processor, the method as provided in some aspects of the present disclosure is implemented.

It should be understood that the foregoing general description and the following detailed description are exemplary and explanatory only, and do not limit the present disclosure.

### BRIEF DESCRIPTION OF THE DRAWINGS

The accompanying drawings, which are incorporated in and constitute a part of this specification, illustrate embodiments consistent with the present disclosure and together with the description, serve to explain the principles of the present disclosure. It is noted that the drawings in the following description are only some embodiments of the present disclosure. For those of ordinary skill in the art, other drawings can be obtained based on these drawings without exerting creative efforts.

FIG. 1 shows a schematic diagram of the application scenario architecture of the text recognition method in an embodiment of the present disclosure.

FIG. 2 shows a schematic flowchart of a text recognition method in an embodiment of the present disclosure.

FIG. 3 shows a schematic diagram of a target image in an embodiment of the present disclosure.

FIG. 4 shows a schematic flowchart of a text recognition method in an embodiment of the present disclosure.

FIG. 5 shows a schematic diagram of the processing flow of the convolution module in an embodiment of the present disclosure.

FIG. 6 shows a schematic diagram of a convolution kernel segmentation process in an embodiment of the present disclosure.

FIG. 7 shows a schematic flowchart for calculating a target high-frequency feature map and a target low-frequency feature map in an embodiment of the present disclosure.

FIG. 8 shows a schematic process flow diagram of a convolution module in an embodiment of the present disclosure.

FIG. 9 shows a schematic flowchart for calculating a target high-frequency feature map and a target low-frequency feature map in an embodiment of the present disclosure.

FIG. 10 shows a schematic diagram of the processing flow of the attention unit in an embodiment of the present disclosure.

FIG. 11 shows a schematic diagram of the processing flow of the attention unit in an embodiment of the present disclosure.

FIG. 12 shows a schematic flowchart for calculating a binarization map in an embodiment of the present disclosure.

FIG. 13 shows a schematic flowchart of a text recognition method in an embodiment of the present disclosure.

FIG. 14 shows a schematic module diagram of a text recognition apparatus in an embodiment of the present disclosure.

FIG. 15 shows a schematic module diagram of the text recognition system in an embodiment of the present disclosure.

FIG. 16 shows a schematic structural diagram of a computer system for implementing an electronic device according to an embodiment of the present disclosure.

### DETAILED DESCRIPTION OF THE EMBODIMENTS

Example embodiments will now be described more fully with reference to the accompanying drawings. Example embodiments may, however, be embodied in various forms and should not be construed as limited to the examples set forth herein. Rather, these embodiments are provided so that the present disclosure will be thorough and complete, and will fully convey the concepts of the example embodiments to those skilled in the art. The described features, structures, or characteristics may be combined in any suitable manner in one or more embodiments.

Furthermore, the drawings are merely schematic illustrations of the present disclosure and are not necessarily drawn to scale. The same reference numerals in the drawings represent the same or similar parts, and thus their repeated description will be omitted. Some of the block diagrams shown in the figures are functional entities and do not necessarily correspond to physically or logically separate entities. These functional entities may be implemented in software forms, or implemented in one or more hardware modules or integrated circuits, or implemented in different networks and/or processor devices and/or microcontroller devices.

It should be noted that in the present disclosure, the terms “comprising”, “configured with”, and “disposed in” are used to express an open inclusion, and indicates that additional elements or components, etc. other than those listed may also be present.

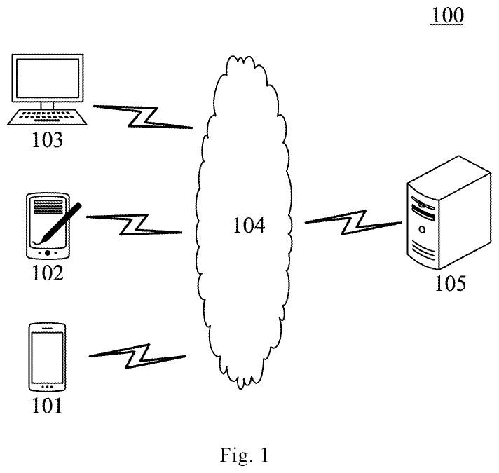

FIG. 1 shows a schematic diagram of the system architecture of an exemplary application environment in which a text recognition method and a text recognition apparatus according to embodiments of the present disclosure can be applied.

As shown in FIG. 1, the system architecture 100 may include one or more of terminal devices 101, 102, 103, a network 104, and a server 105. The network 104 is a medium used to provide communication links between the terminal devices 101, 102, 103 and the server 105. The network 104 may include various connection types, such as wired, wireless communication links, or fiber optic cables. The terminal devices 101, 102, and 103 may be desktop computers, smart phones, tablets, notebook computers, smart watches, etc., but are not limited thereto.

It should be understood that the number of terminal devices, networks, and servers in FIG. 1 is only illustrative. Depending on implementation requirements, there may be any number of terminal devices, networks, and servers. For example, the server 105 may be an independent physical server, or may be a server cluster or distributed system composed of multiple physical servers. Alternatively, the server 105 may be a cloud server that provides cloud services, cloud databases, cloud computing, cloud functions, cloud storage, network services, cloud communications, middleware services, domain name services, security services, CDN, and basic cloud computing services such as big data and artificial intelligence platforms.

The text recognition method provided by the embodiments of the present disclosure may generally be executed on the server 105. Accordingly, the text recognition apparatus is generally provided in the server 105. For example, the user may upload the target image to the server 105 through the network 104 on the terminal device 101, 102 or 103. The server 105 executes the text recognition method provided by the embodiments of the present disclosure to perform text recognition on the received target image, and feed back the recognized text information to the terminal device through the network 104. However, in some embodiments, the text recognition method provided by the embodiments of the present disclosure may also be executed by the terminal devices 101, 102, and 103. Accordingly, the text recognition apparatus may also be provided in the terminal devices 101, 102, and 103. This is not particularly limited in this exemplary embodiment.

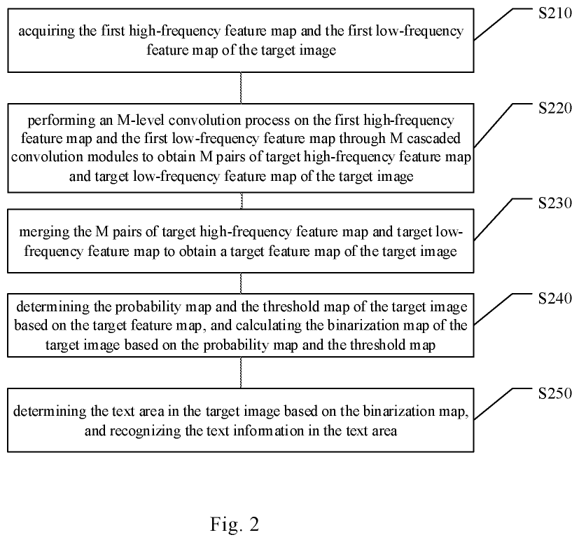

Referring to FIG. 2, the text recognition method provided in an exemplary embodiment may include the following steps S210 to S250.

Step S210: acquiring the first high-frequency feature map and the first low-frequency feature map of the target image.

Step S220, performing an M-level convolution process on the first high-frequency feature map and the first low-frequency feature map through M cascaded convolution modules to obtain M pairs of target high-frequency feature map and target low-frequency feature map of the target image, where M is a positive integer.

Step S230: merging the M pairs of target high-frequency feature map and target low-frequency feature map to obtain a target feature map of the target image.

Step S240: determining the probability map and the threshold map of the target image based on the target feature map, and calculating the binarization map of the target image based on the probability map and the threshold map.

Step S250: determining the text area in the target image based on the binarization map, and recognizing the text information in the text area.

In the text recognition method provided by the exemplary embodiments of the present disclosure, first, the high-frequency feature information and the low-frequency feature information of the target image are respectively extracted, and the feature information of different scales is output through the convolution modules of the pyramid structure. Then, the high-frequency feature information and the low-frequency feature information of different scales are merged to obtain a feature-enhanced target feature map. After that, text recognition can be performed based on the target feature map. On the one hand, due to the merging of high-frequency feature information and low-frequency feature information of different scales, the high resolution of low-level features and the semantic information of high-level features are retained. Therefore, the accuracy of recognition may be improved. At the same time, compared with traditional convolution methods, since a full feature extraction process is not required, the computational volume of the model is reduced, thereby improving the operation efficiency of the model.

Below, each step of the text recognition method in this exemplary embodiment will be described in more detail with reference to the accompanying drawings and embodiments.

In step S210, the first high-frequency feature map and the first low-frequency feature map of the target image are acquired.

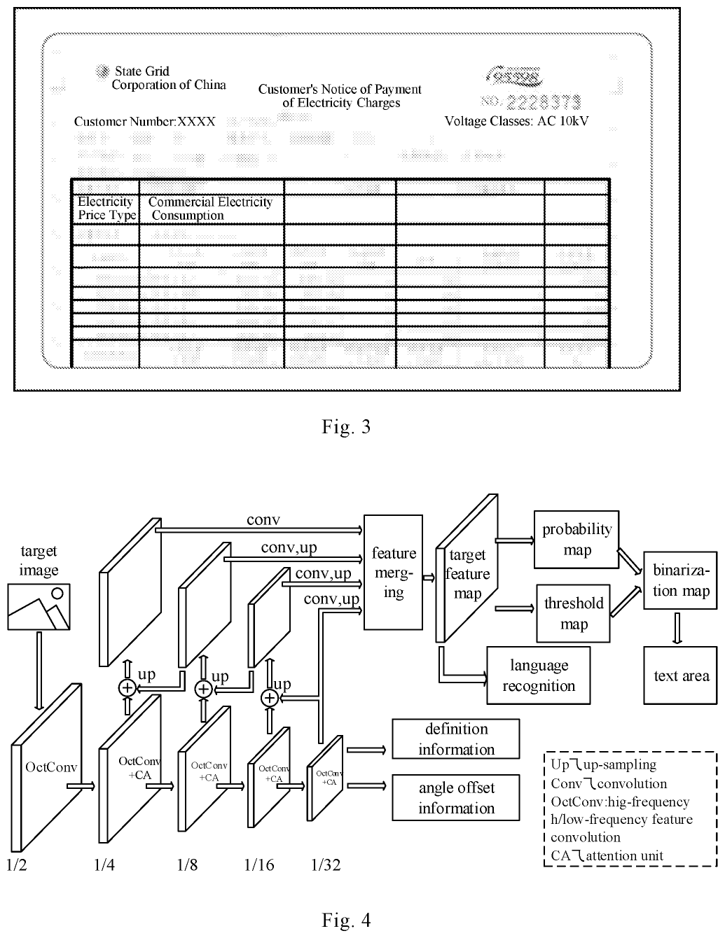

In this example implementation, the target image may be any image to be recognized that contains text information. For example, the target image may be materials captured using a digital camera, camera, or mobile phone and uploaded (such as bills, vouchers, etc.). Refer to FIG. 3, which is a schematic diagram of a target image, showing a natural scene image of an electricity bill. In some exemplary embodiments of the present disclosure, the target image may also be an image collected or generated through other methods (such as an image obtained through screen capture, etc.). Alternatively, the target image may also be other types of images (such as test papers, handwritings), etc. It is not particularly limited in this exemplary embodiment.

After acquiring the target image, the first high-frequency feature map and the first low-frequency feature map of the target image may be acquired. The first high-frequency feature map is a feature map generated based on the high-frequency information in the target image. The first low-frequency feature map is a feature map generated based on the low-frequency information in the target image. The resolution of the first high-frequency feature map may be the same as the resolution of the target image. The resolution of the first low-frequency feature map is generally lower than the resolution of the target image. In this example implementation, the first high-frequency feature map and the first low-frequency feature map of the target image may be obtained after decoding the code stream of the target image. Also, the first high-frequency feature map and the first low-frequency feature map of the target image may be obtained by the pre-trained Octave Convolution (OctConv) module performing a feature extraction process on the target image. This exemplary embodiment is not limited thereto.

In step S220, an M-level convolution process is performed on the first high-frequency feature map and the first low-frequency feature map through M cascaded convolution modules to obtain M pairs of target high-frequency feature map and target low-frequency feature map, where M is a positive integer.

Referring to FIG. 4, in this example implementation, the backbone network of the corresponding text recognition system includes M cascaded convolution modules. For example, M may be 4. When M is 4, it is adapted to targets images of most resolutions, and thus the generalization of the system will be stronger. However, it is easy to understand that those skilled in the art can also set different values of M according to factors such as the resolution of the target image and the requirements for recognition accuracy. For example, when the resolution of the target image is high, the value of M may be high.

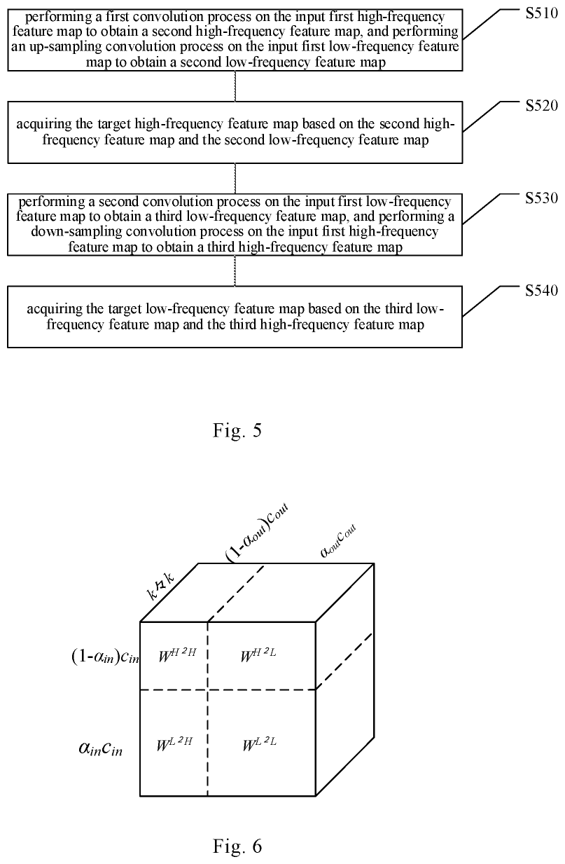

Referring to FIG. 5, in this example implementation, each convolution module may perform a convolution process on the first high-frequency feature map and the first low-frequency feature map of the target image through the following steps S510 to S540.

Step S510: performing a first convolution process on the input first high-frequency feature map to obtain a second high-frequency feature map, and performing an up-sampling convolution process on the input first low-frequency feature map to obtain a second low-frequency feature map.

In this example implementation, the convolution module may use a convolution kernel as shown in FIG. 6 when performing the convolution process. The convolution kernel W with a size of k×k in ordinary convolution operations may be split into two parts [W^{H}, W^{L}]. The first part W^{H} is used for convolution of the first high-frequency feature map. The second part W^{L} is used for convolution of the first low-frequency feature map. The first part W^{H} is further split into two parts, one being within frequency and the other being between frequencies, that is, W^{H}=[W^{H→H}, W^{H→L}]. The second part W^{L} is further split into two parts, one being within frequency and one being between frequencies, that is, W^{L}=[W^{L→L}, W^{L→H}]. In the drawings, the parameters cᵢₙ and cₒᵤₜ are used to represent the number of input channels and the number of output channels respectively. The parameters αᵢₙ and αₒᵤₜ are used to control proportions of the low-frequency information part of the input feature map and the output feature map respectively. For example, αᵢₙ and αₒᵤₜ may both be 0.5. That is, the low-frequency information part and the high-frequency information part of the input feature map (and also of the output feature map) are the same. However, αᵢₙ and αₒᵤₜ may also be different. It is not specifically limited in this exemplary embodiment.

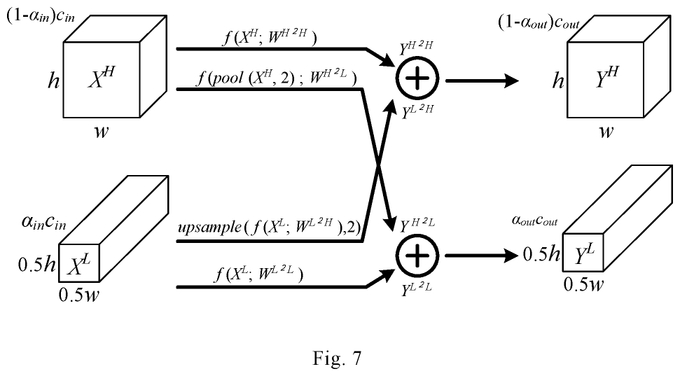

After determining the convolution kernel, a first convolution process is performed on the input first high-frequency feature map to obtain a second high-frequency feature map. For example, referring to FIG. 7, the second high-frequency feature map Y^{H→H} is as follows:

$${Y}^{H \to H} = f ( {X}^{H} , {W}^{H \to H} ) .$$

Similarly, with continued reference to FIG. 7, the second low-frequency feature map Y^{L→H} is as follows:

$${Y}^{L \to H} = upsample ( f ( {X}^{L} ; {W}^{L \to H} ) , 2 ) .$$

X^{L} is the first high-frequency feature map, X^{L} is the first low-frequency feature map, f(;) represents the first convolution operation; upsample(,) represents the up-sampling operation. In this example implementation, a 2× up-sampling operation is performed, and the resolution is expanded to four times, so that the resolutions of the second low-frequency feature map and the second high-frequency feature map are the same.

Step S520: acquiring the target high-frequency feature map based on the second high-frequency feature map and the second low-frequency feature map. For example, with continued reference to FIG. 7, the target high-frequency feature map Y^{H} is as follows:

$${Y}^{H} = {Y}^{H \to H} + {Y}^{L \to H}$$

where + represents an element-size addition operation.

Step S530: performing a second convolution process on the input first low-frequency feature map to obtain a third low-frequency feature map, and performing a down-sampling convolution process on the input first high-frequency feature map to obtain a third high-frequency feature map.

Similar to the above step S510, the second convolution process is performed on the input first low-frequency feature map to obtain the third low-frequency feature map. For example, referring to FIG. 7, the third low-frequency feature map Y^{L→L} is as follows:

$${Y}^{L \to L} = f ( {X}^{L} ; {W}^{L \to L} ) .$$

Similarly, with continued reference to FIG. 7, the second low-frequency feature map Y^{L→H} is as follows:

$${Y}^{H \to L} = f ( pool ( {X}^{H} , 2 ) ; {W}^{H \to L} )$$

where, X^{H} is the first high-frequency feature map, X^{L} is the first low-frequency feature map, f(;) represents the second convolution operation; pool(,) represents a down-sampling (or pooling) operation. In this example implementation, the down-sampling step has a size of 2, thereby reducing the resolution to a quarter, so that the resolutions of the third high-frequency feature map and the first low-frequency feature map are the same.

Step S540: acquiring the target low-frequency feature map based on the third low-frequency feature map and the third high-frequency feature map. For example, with continued reference to FIG. 7, the target low-frequency feature map Y^{L} is as follows:

$${Y}^{L} = {Y}^{L \to L} + {Y}^{H \to L}$$

where + represents an element-size addition operation.

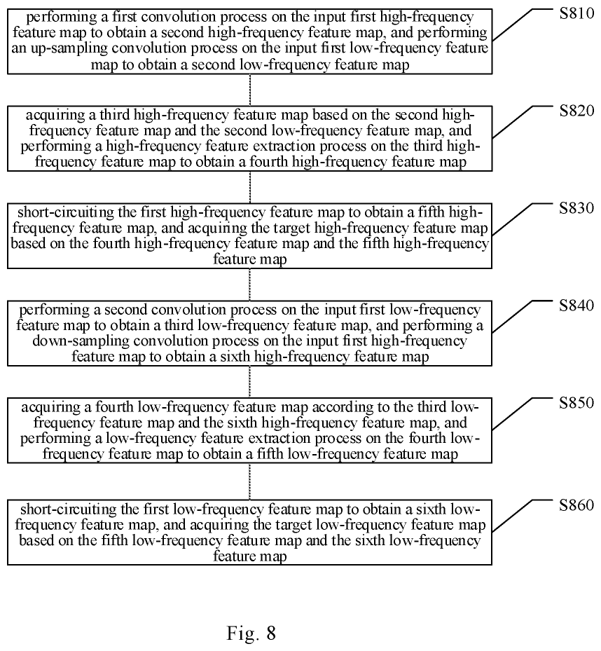

Referring to FIG. 8, in order to avoid losing too much useful information without filtering during the down-sampling process, in some exemplary embodiments of the present disclosure, each convolution module may also perform the following step S810 to step S860 so that a convolution process is performed on the first high-frequency feature map and the first low-frequency feature map of the target image.

Step S810: performing a first convolution process on the input first high-frequency feature map to obtain a second high-frequency feature map, and performing an up-sampling convolution process on the input first low-frequency feature map to obtain a second low-frequency feature map. This step is similar to the above-mentioned step S510, so the details will not be repeated here.

Step S820: acquiring a third high-frequency feature map based on the second high-frequency feature map and the second low-frequency feature map, and performing a high-frequency feature extraction process on the third high-frequency feature map to obtain a fourth high-frequency feature map.

In this example implementation, similar to the above step S520, for example, the third high-frequency feature map Y^{H1} as shown below can be acquired:

$${Y}^{H 1} = {Y}^{H \to H} + {Y}^{L \to H} .$$

After the third high-frequency feature map is acquired, a high-frequency feature extraction process may be performed on the third high-frequency feature map through processing such as down-sampling, up-sampling, convolution, or filtering. Taking the convolution process as an example, the fourth high-frequency feature map Y^{H2} as shown below may be obtained:

Y^{H2}=f(Y^{H1};W^{H}),

where f(;) represents the third convolution operation.

Step S830: short-circuiting the first high-frequency feature map to obtain a fifth high-frequency feature map, and acquiring the target high-frequency feature map based on the fourth high-frequency feature map and the fifth high-frequency feature map.

In this example implementation, the fifth high-frequency feature map needs to have the same resolution as the fourth high-frequency feature map. Therefore, if the high-frequency feature extraction process is performed in the above step S820, and the step size of the convolution operation is greater than 1, it is necessary to short-circuit the first high-frequency feature map to ensure that the two have the same resolution. For example, the fifth high-frequency feature map Y^{H3} may be obtained as follows:

Y^{H3}=shortcut(X^{H}),

where shortcut represents a short-circuit connection.

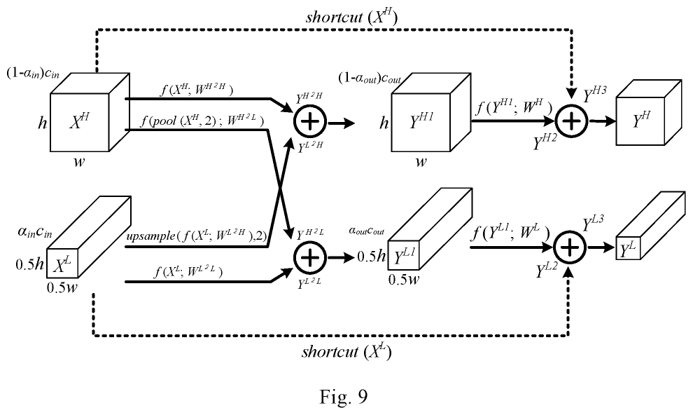

Furthermore, with continued reference to FIG. 9, the target high-frequency feature map Y^{H} is as follows:

$${Y}^{H} = {Y}^{H 2} + {Y}^{H 3} .$$

Step S840: performing a second convolution process on the input first low-frequency feature map to obtain a third low-frequency feature map, and performing a down-sampling convolution process on the input first high-frequency feature map to obtain a sixth high-frequency feature map. This step is similar to the above-mentioned step S630, so the details will not be repeated here.

Step S850: acquiring a fourth low-frequency feature map according to the third low-frequency feature map and the sixth high-frequency feature map, and performing a low-frequency feature extraction process on the fourth low-frequency feature map to obtain a fifth low-frequency feature map.

In this example implementation, similar to the above step S540, for example, the fourth low-frequency feature map Y^{L1} as shown below may be obtained:

$${Y}^{L 1} = {Y}^{L \to L} + {Y}^{H \to L} .$$

After the fourth low-frequency feature map is acquired, a low-frequency feature extraction process may also be performed on the fourth low-frequency feature map through processing such as down-sampling, up-sampling, convolution, or filtering. Taking the convolution processing as an example, for example, the fifth low-frequency feature map Y^{L2} may be obtained as follows:

Y^{L2}=f(Y^{L1};W^{L}),

where f(;) represents the fourth convolution operation.

Step S860: short-circuiting the first low-frequency feature map to obtain a sixth low-frequency feature map, and acquiring the target low-frequency feature map based on the fifth low-frequency feature map and the sixth low-frequency feature map.

In this example implementation, the sixth low-frequency feature map needs to have the same resolution as the fifth high-frequency feature map. Therefore, if during the process of low-frequency feature extraction in the above step S850, the step size of the convolution operation is greater than 1, then it is necessary to short-circuit the first low-frequency feature map to ensure that the two have the same resolution. For example, the sixth low-frequency feature map Y^{L3} may be obtained as follows:

Y^{L3}=shortcut(X^{L}),

where shortcut represents a short-circuit connection.

Furthermore, with continued reference to FIG. 9, the target low-frequency feature map Y^{L} is as follows:

$${Y}^{L} = {Y}^{L 2} + {Y}^{L 3} .$$

In the above exemplary embodiment, the process of a convolution module performing a convolution process on the input high-frequency feature map and low-frequency feature map to obtain the target high-frequency feature map and the target low-frequency feature map of the target image is exemplified. In some exemplary embodiments of the present disclosure, an attention unit may also be introduced in the convolution module, and then the feature weight output by the convolution module may be adjusted through the attention unit. By introducing the attention unit, adjacent channels can be involved in the attention prediction of the current channel. Then, the weight of each channel can be dynamically adjusted, and the weight of text features can be enhanced to improve the expressive ability of the method in the present disclosure, thereby realizing the filter of background information.

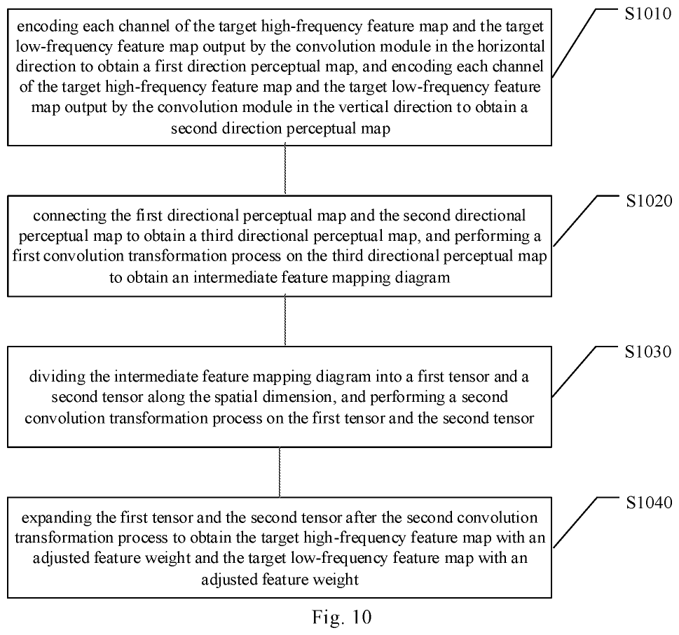

Referring to FIG. 10, in this example implementation, the attention unit may adjust the feature weight output by the convolution module through the following steps $1010 to S1040.

Step S1010: encoding each channel of the target high-frequency feature map and the target low-frequency feature map output by the convolution module in the horizontal direction to obtain a first direction perceptual map, and encoding each channel of the target high-frequency feature map and the target low-frequency feature map output by the convolution module in the vertical direction to obtain a second direction perceptual map.

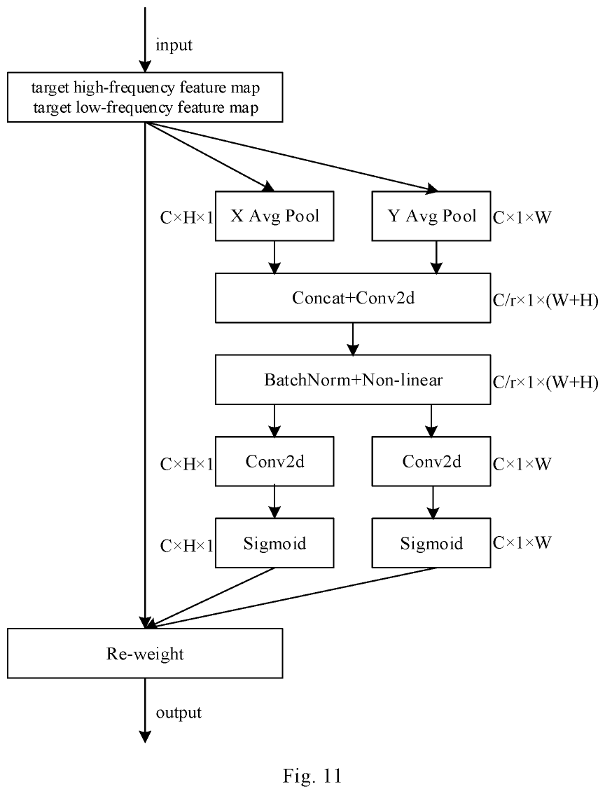

In this example implementation, in order to enable the attention unit to capture spatial long-range dependencies with precise location information, global pooling may be decomposed into a pair of one-dimensional feature encoding operations according to the following formula. For example, for the input target high-frequency feature map and target low-frequency feature map, a pooling kernel of size (H, 1) may be used to encode each channel along the horizontal coordinate direction (corresponding to the X Avg Pool section shown in FIG. 11). Furthermore, the output z_{c}^{h}(h) of the c-th channel with a height of h may be as follows:

$${z}_{c}^{h} ( h ) = \frac{1}{W} {\sum }_{0 \leq i < W} {x}_{c} ( h , c ) .$$

Similarly, for the input target high-frequency feature map and target low-frequency feature map, a pooling kernel of size (1, W) may be used to encode each channel along the vertical coordinate direction (corresponding to the Y Avg Pool section shown in FIG. 11). Furthermore, the output z_{c}^{h}(h) of the c-th channel with a width of w may be as follows:

$${z}_{c}^{w} ( w ) = \frac{1}{H} {\sum }_{0 \leq i < H} {x}_{c} ( j , i ) .$$

In the above process, the attention unit can capture long-range dependencies along one spatial direction and save precise position information along another spatial direction, thus helping to more accurately locate the target of interest.

Step S1020: connecting the first directional perceptual map and the second directional perceptual map to obtain a third directional perceptual map, and performing a first convolution transformation process on the third directional perceptual map to obtain an intermediate feature mapping diagram.

In this exemplary embodiment, the first direction perception map z^{h} and the second direction perception map z^{w} are first connected to obtain a third direction perception map. Then, the following first convolution transformation process may be performed on the third directional perceptual map to obtain the intermediate feature mapping diagram f.

f=δ(F₁([z^{h},z^{w}])).

where, [,] represents the connection operation along the spatial dimension; δ is the nonlinear activation function; F₁( ) represents the first convolution transformation function with a convolution kernel of 1×1. Through the above formula, the intermediate feature mapping diagram f∈R^{C/r×(H+W)} is obtained, where r represents the step size of the first convolution transformation (corresponding to the Concat+Conv2d section shown in FIG. 11).

Step S1030: dividing the intermediate feature mapping diagram into a first tensor and a second tensor along the spatial dimension, and performing a second convolution transformation process on the first tensor and the second tensor.

In this example implementation, f may be divided into two separate vectors along the spatial dimension, namely the first tensor f^{h}∈R^{C/r×H} and the second tensor f^{w}∈R^{C/r×W} (corresponding to the BatchNorm+Non-linear section shown in FIG. 11). Then, two convolution transformation functions with a convolution kernel of 1×1 are used to perform a second convolution transformation process on the first tensors f^{h} and f^{w} (corresponding to a pair of Conv2d sections shown in FIG. 11). Furthermore, the number of channels being the same as the input characters is obtained. For example,

g^{h}=σ(Fₕ(f^{h}),

g^{w}==σ(F_{w}(f^{w})),

where σ is the Sigmoid activation function (corresponding to a pair of Sigmoid sections shown in FIG. 11). Fₕ( ) and F_{w}( ) represent the second convolution transformation functions with a convolution kernel of 1×1.

Step S1040: expanding the first tensor and the second tensor after the second convolution transformation process to obtain the target high-frequency feature map with an adjusted feature weight and the target low-frequency feature map with an adjusted feature weight (corresponding to Re-weight section shown in FIG. 11).

Following the above example, in this example implementation, the target high-frequency feature map with the adjusted feature weight and the target low-frequency feature map with the adjusted feature weight may be as follows:

$${γ}_{c \vert H} ( i , j ) = {x}_{c \vert H} ( i , j ) \times {g}_{c}^{h} ( i ) \times {g}_{c}^{w} ( i ) ,$$

$${γ}_{c \vert L} ( i , j ) = {x}_{c \vert L} ( i , j ) \times {g}_{c}^{h} ( i ) \times {g}_{c}^{w} ( i ) ,$$

x_{c|H} represents the information of the c channel feature of the target high-frequency feature map before feature weight adjustment; y_{c|H} represents the information of the c channel of the target high-frequency feature map after weight adjustment; x_{c|L} represents the information of the c channel feature of the target low-frequency feature map before feature weight adjustment; y_{c|L} represents the information of the c channel of the target low-frequency feature map after weight adjustment.

In the above exemplary embodiment, the process of a convolution module performing a convolution process on the input high-frequency feature map and low-frequency feature map to obtain the target high-frequency feature map and the target low-frequency feature map of the target image is exemplified. The next level convolution module may use the target high-frequency feature map and the target low-frequency feature map output by the previous convolution module as the input first high-frequency feature map and second low-frequency feature map at this level, thereby using similar convolution processes to output the target high-frequency feature map and the target low-frequency feature map of the target image. Since there are M convolution modules in total, a total of M pairs of target high-frequency feature map and target low-frequency feature map will be output. Since the convolution process of each convolution module is similar, the details will not be repeated.

In step S230, the M pairs of target high-frequency feature map and target low-frequency feature map are merged to obtain a target feature map of the target image.

With continued reference to FIG. 4, in this example implementation, the n-th level convolution module is also used to perform a 2⁽ⁿ⁺¹⁾x down-sampling process on the input first high-frequency feature map and first low-frequency feature map. For example, the 1^{st} level to 4^{th} level convolution modules sequentially perform the 4×, 8×, 16×, 32× down-sampling process on the input first high-frequency feature map and first low-frequency feature map, so that the (¼)×, (⅛)×, ( 1/16)×, ( 1/32)× target high-frequency feature map and target low-frequency feature map can be acquired.

In order to facilitate the merging of feature information of different dimensions, the target high-frequency feature map and the target low-frequency feature map output by each convolution module need to be adjusted to the same resolution. Therefore, in this example implementation, for the target high-frequency feature map and the target low-frequency feature map output by the attention unit included in the n-th level of convolution module, a 2⁽ⁿ⁺¹⁾x up-sampling process is performed. For example, for the target high-frequency feature map and the target low-frequency feature map output by the 1^{st} level to 4^{th} level convolution modules, the 4× 8×, 16×, 32× up-sampling process is performed in sequence.

The M pairs of target high-frequency feature map and target low-frequency feature map after the up-sampling process are merged in corresponding dimensions and connected in corresponding channel numbers to obtain the target feature map of the target image. For example, in this example implementation, the target high-frequency feature map and the target low-frequency feature map may be firstly added and merged in corresponding dimensions to obtain enhanced feature information. Then, the channel numbers of different scales are connected respectively, and the 1×1 convolution kernel rearranges and combines the connected features to obtain the target feature map of the target image. In this example implementation, the target feature map of the target image is the merging of semantic information of feature maps of different scales. Therefore, the recognition accuracy of the subsequent text area may be improved. At the same time, the feature merging process performs feature merging by combining the features of different scales output by each convolution module in the pyramid way, and combines the high resolution of low-level features and the semantic information of high-level features, thereby further improving the robustness of text area recognition.

In step S240, a probability map and a threshold map of the target image are determined based on the target feature map, and a binarization map of the target image is calculated based on the probability map and the threshold map.

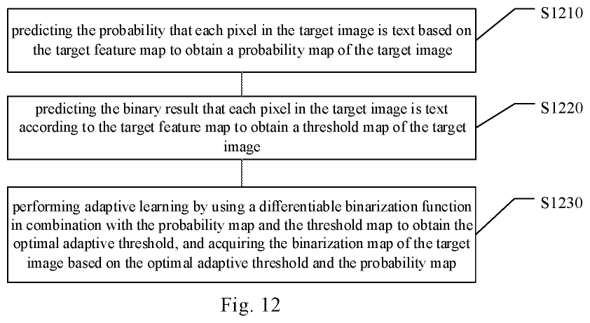

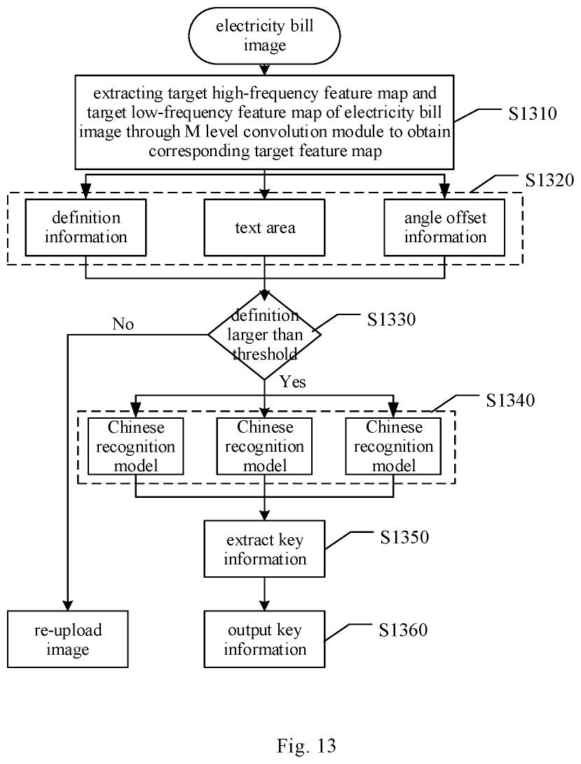

Referring to FIG. 12, in this exemplary embodiment, the binarization map of the target image can be calculated through the following steps S1210 to S1230.

Step S1210: predicting the probability that each pixel in the target image is text based on the target feature map to obtain a probability map of the target image. For example, in this exemplary embodiment, the target feature map may be input into a pre-trained neural network used to obtain a probability map, and the probability that each pixel in the target image is text can be determined, thereby obtaining a probability map of the target image (0˜1). In other exemplary embodiments of the present disclosure, algorithms such as Vatti Clipping (graphics polygon clipping) may also be used to resize the target feature map according to a preset thumbnail ratio to obtain the probability map. This is not particularly limited in the exemplary embodiments.

Step S1220: predicting the binary result that each pixel in the target image is text according to the target feature map to obtain a threshold map of the target image. For example, in this exemplary embodiment, the target feature map may be input into a neural network pre-trained to obtain a binary map, and a binary result is predicted about each pixel in the target image being text (0 or 255), and then the threshold map of the target image is obtained. In other exemplary embodiments of the present disclosure, algorithms such as Vatti Clipping may also be used to expand the target feature map according to a preset expansion ratio to obtain the threshold map, which is not particularly limited in this exemplary embodiment.

Step S1230: in combination with the probability map and the threshold map, a differentiable binarization function is used to perform adaptive learning to obtain the optimal adaptive threshold, and the optimal adaptive threshold and the probability map are used to obtain the binarization map of the target image.

The above threshold map is used to predict the probability that each pixel in the target image is text. In order to learn the threshold corresponding to each pixel in the probability map, in this example embodiment, the pixel P of the probability map and the threshold T of the pixel point in the threshold map may be brought into the differentiable binarization function for adaptive learning, and its own optimal adaptive threshold T is learned through the pixel point P. The mathematical expression of the differentiable binarization function is as follows:

$${B}_{i , j} = \frac{1}{1 + {e}^{- k ( {P}_{ij} - {T}_{ij} )}} .$$

where B represents the estimated approximate binarization map, T is the optimal adaptive threshold that needs to be learned from the neural network, P_{i,j} represents the current pixel point, k is the amplification factor, (i, j) represents the coordinate position of each point in the figure.

In the traditional binarization process, the binarization function is not differentiable, which leads to poor results in subsequent text area recognition. In order to enhance the generalization of text area recognition, in this example implementation, the binarization function is transformed into a differentiable form, so that iterative learning in the network can be achieved. Compared with the traditional binarization function, this function is differentiable in nature and has high flexibility. Each pixel point may be adaptively binarized in the network, and the adaptive threshold of each pixel can be learned through the network. The adaptive threshold is also the best adaptive threshold, which makes the final output threshold of the neural network have strong generalization for the binarization process of the probability map.

After determining the best adaptive threshold, each pixel value P may be compared with the best adaptive threshold T in the probability map based on the best adaptive threshold. Specifically, when P is greater than or equal to T, the pixel value of the probability map may be set to 1, which is considered to be a valid text area; otherwise, it is set to 0, which may be considered to be an invalid area, thereby obtaining the binarization map of the target image.

In step S250, a text area in the target image is determined according to the binarization map, and text information in the text area is recognized.

After obtaining the binarization map of the target image, a contour extraction algorithm such as cv2 may be used to extract the contour of the target image to obtain a picture of the text area, where cv2 is a computer vision library of OpenCV (a cross-platform computer vision and machine learning software library). However, this exemplary embodiment is not limited to this. After determining the text area in the target image, a text recognition model such as Convolutional Recurrent Neural Network (CRNN) may be used to recognize the text information in the text area.

Taking the text recognition model being CRNN as an example, CRNN may include a convolutional layer, a recurrent layer, and a transcription layer (CTC loss). After the picture of the text area is input to the convolution layer, the convolution feature map is extracted in the convolution layer. Then, the extracted convolution feature map is input to the recurrent layer to extract the feature sequence, and Long Short-Term Memory (LSTM) neurons and bidirectional Recurrent Neural Network (RNN) may be used for processing. Finally, the features output by the recurrent layer are input into the transcription layer for text recognition and output.

In addition, in this example implementation, the CRNN model may also be trained in advance using sample data of different languages to obtain text recognition models corresponding to different languages. For example, the language may be Chinese, English, Japanese, numeric, etc., and the corresponding text recognition model may include a Chinese recognition model, an English recognition model, a Japanese recognition model, a numeric recognition model, etc. Furthermore, after determining the text area in the target image, the language of the text contained in the target image may also be first predicted based on the target feature map. Then, the corresponding text recognition model may be determined according to the language of the text contained in the target image to recognize text information in the text area.

In this example implementation, the language of the text contained in the target image may be predicted through a multi-classification model such as a Softmax regression model, a Support Vector Machines (SVM) model, and other models. Taking the SVM model as an example, the classification plane of the SVM model may be determined in advance based on the above-mentioned target feature map of the sample image and the language calibration result of each sample image. The language calibration result of each sample image refers to the correct language result about the text in the sample image determined manually or by other means. Furthermore, the above target feature map may be input into the trained SVM model, and the language of the text in the image to be recognized may be obtained through the classification plane of the SVM model.

With continued reference to FIG. 4, in some exemplary embodiments of the present disclosure, before text area recognition is performed, the target high-frequency feature map and the target low-frequency feature map output by the attention unit included in the M-th level (for example 4th level in the figure) convolution module are used to predict the definition information of the target image. Furthermore, when the definition of the target image is too low, the subsequent text recognition process may not be performed, thus increasing the robustness of the algorithm to abnormal situations and reducing ineffective calculation work. In some exemplary embodiments, when it is determined that the definition of the target image is too low, the user may also be prompted through prompt information to re-provide an image with a higher definition.

In this example implementation, the definition information of the target image may be predicted through a classification model such as a Support Vector Machines (SVM) model. The definition information of the target image may also be predicted through a definition evaluation model based on edge gradient detection, correlation principle, statistical principle, or transformation. Taking the definition evaluation model based on edge gradient detection as an example, it may be the Brenner gradient algorithm, where the square of the gray difference between two adjacent pixels is calculated, or the Tenengrad gradient algorithm (or Laplacian gradient algorithm), where the Sobel operator (or Laplacian operator) may be used to extract the gradients in the horizontal and vertical directions respectively. It is not particularly limited in this exemplary embodiment.

With continued reference to FIG. 4, in some exemplary embodiments of the present disclosure, the target high-frequency feature map and the target low-frequency feature map output by the attention unit included in the M-th level (4th level in the figure) convolution module may also be used to predict the angle offset information of the target image. Furthermore, it is easy to make corresponding offset adjustments during subsequent text recognition based on the angle offset information of the image, thereby improving the success rate of recognition. In addition, it is also easy to perform layout analysis and other subsequent processing based on the angle offset information of the image. It is not limited to this in this exemplary embodiment. In some exemplary embodiments of the present disclosure, only the offset direction of the target image may also be output, such as 0 degrees, 90 degrees, 180 degrees, and 270 degrees.

In this example implementation, the angle offset information of the target image may be measured through a multi-classification model such as Residual Network (ResNet). When the icon image is a regular-shaped image such as a document, voucher, or bill, the angle offset information of the target image may also be determined through the method of corner point detection. For example, when the target image is an electricity bill, a corner point detection process may be performed first on the electricity bill image to determine the corner position of each corner point in the electricity bill area of the image. Then, based on the corner position of each corner point in the electricity bill area, the multi-dimensional offset parameter may be determined. The multi-dimensional offset parameter may be used to characterize the degree of offset about the offset of the electricity bill along the horizontal axis, longitudinal axis, and vertical axis of the spatial coordinate system. Finally, based on the multi-dimensional offset parameter, the spatial posture of the target electricity bill image may be determined, and then its angle offset information may be determined.

Referring to FIG. 13, it is shown the overall process of text information recognition for an electricity bill image by the text recognition method in this exemplary embodiment. In step S1310, the target high-frequency feature map and the target low-frequency feature map of the electricity bill image are extracted through the above-mentioned convolution module, and the target feature map of the target image is obtained based on the target high-frequency feature map and the target low-frequency feature map of the electricity bill image. In step S1320, the definition information and the angle offset information of the electricity bill image are predicted based on the target high-frequency feature map and the target low-frequency feature map of the electricity bill image; and text area in the image is recognized based on the target feature map of the electricity bill image. In step S1330, it is determined whether the electricity bill image is clear enough according to the definition information of the electricity bill image. For example, if the definition is greater than the preset threshold, it is continued to perform the subsequent step S1340. If the definition is less than the preset threshold, then users are prompted to re-upload a clearer image of the electricity bill. In step S1340, the language type of the electricity bill image may be determined based on the target feature map thereof, and then a corresponding text recognition model may be selected according to the language type. For example, the text recognition model may include a Chinese recognition model, an English recognition model, a numeric recognition model, etc. In step S1350, the text information is obtained by recognizing the text area by the text recognition model, and key information is extracted based on the text information, such as user number, user name, payment amount, etc. In step 1360, the extracted key information may be output to the user or the extracted key information may be stored in a database.

It should be understood that although various steps in the flowchart of the accompanying drawings are shown in sequence as indicated by arrows, these steps are not necessarily performed in the order indicated by arrows. Unless explicitly stated in this description, the execution of these steps is not strictly limited in order, and they may be executed in other orders. Moreover, at least some of the steps in the flow chart of the accompanying drawings may include multiple sub-steps or multiple stages. These sub-steps or stages are not necessarily executed at the same time, but may be executed at different times. Also, their execution order does not necessarily need to be performed sequentially, but may be performed in turn or alternately with other steps or sub-steps of other steps or at least part of the stages.

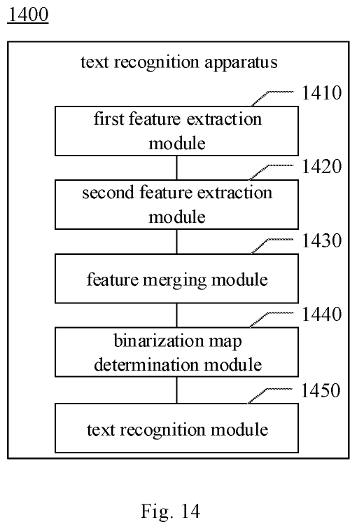

Further, an example embodiment also provides a text recognition apparatus. Referring to FIG. 14, the text recognition apparatus 1400 may include a first feature extraction module 1410, a second feature extraction module 1420, a feature merging module 1430, a binarization map determination module 1440, and a text recognition module 1450.

The first feature extraction module 1410 may be used to acquire the first high-frequency feature map and the first low-frequency feature map of the target image. The second feature extraction module 1420 may be configured to perform an M-level convolution process on the first high-frequency feature map and the first low-frequency feature map through M cascaded convolution modules to obtain M pairs of target high-frequency feature and target low-frequency feature map of the target image, where M is a positive integer. The feature merging module 1430 may be used to merge the M pairs of target high-frequency feature map and target low-frequency feature map to obtain a target feature map of the target image. The binarization map determination module 1440 may be configured to determine the probability map and the threshold map of the target image based on the target feature map, and to calculate the binarization map of the target image based on the probability map and the threshold map. The text recognition module 1450 may be configured to determine a text area in the target image according to the binarization map, and recognize text information in the text area.

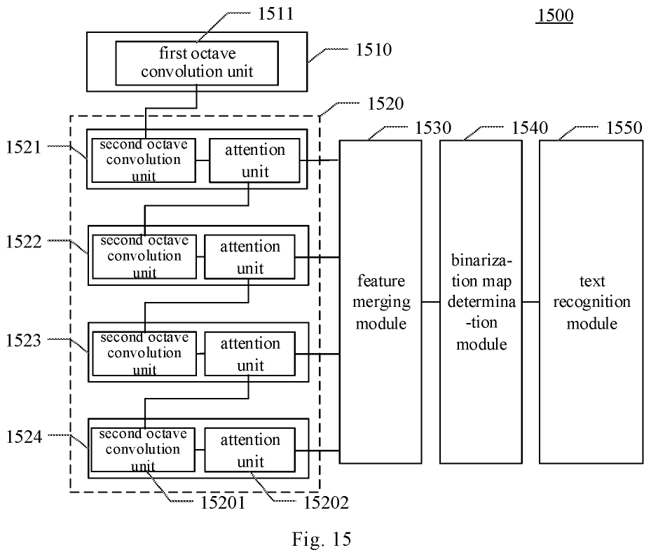

Further, an example embodiment also provides a text recognition system. Referring to FIG. 15, the text recognition system 1500 may include a first feature extraction module 1510, a second feature extraction module 1520, a feature merging module 1530, a binarization map determination module 1540, and a text recognition module 1550.

The first feature extraction module 1510 includes a first octave convolution unit 1511. The first octave convolution unit 1511 is used to acquire the first high-frequency feature map and the first low-frequency feature map of the target image. In this exemplary embodiment, the flow of the convolution processing of the first octave convolution unit 1511 is similar to the above-mentioned step S510 to step S540, or similar to the above-mentioned step S810 to step S860, so the details are not repeated here.

The second feature extraction module 1520 includes M cascaded convolution modules. For example, referring to FIG. 15, the first to fourth convolution modules 1521 to 1524 are included. Each of the convolution modules includes a second octave convolution unit 15201 and an attention unit 15202. The second octave convolution unit 15201 is used to perform an octave convolution process based on the input high-frequency feature map and low-frequency feature map to obtain the target high-frequency feature map and the target low-frequency feature map of the target feature map. The attention unit 15202 is used to adjust the feature weights of the target high-frequency feature map and the target low-frequency feature map based on the attention mechanism. The second octave convolution unit of the first level convolution module inputs the first high-frequency feature map and the first low-frequency feature map. The second octave convolution unit of the second level to M-th level (the second to fourth level as shown in the figure) inputs the target high-frequency feature map and the target low-frequency feature map output by the previous level convolution module. In this exemplary embodiment, the convolution process of the second octave convolution unit 15201 is similar to the above-mentioned step 510 to step S540, or similar to the above-mentioned step S810 to step S860. The process of the attention unit 15202 is similar to the above-mentioned step S1010 to step S1040, and are therefore not repeated here.

The feature merging module 1530 is used to merge the M pairs of target high-frequency feature map and target low-frequency feature map after feature weight adjustment to obtain a target feature map of the target image.

The binarization map determination module 1540 is configured to determine the probability map and the threshold map of the target image based on the target feature map, and to calculate the binarization map of the target image based on the probability map and the threshold map.

The text recognition module 1550 is configured to determine a text area in the target image according to the binarization map, and recognize text information in the text area.

In an exemplary embodiment of the present disclosure, the second octave convolution unit 15201 is specifically configured to: perform a first convolution process on the input high-frequency feature map to obtain a second high-frequency feature map, perform an up-sampling convolution process on the input low-frequency feature map to obtain a second low-frequency feature map; acquire the target high-frequency feature map according to the second high-frequency feature map and the second low-frequency feature map; perform a second convolution process on the input low-frequency feature map to obtain a third low-frequency feature map, and perform a down-sampling convolution process on the input high-frequency feature map to obtain a third high-frequency feature map; and acquire the target low-frequency feature map according to the third low-frequency feature map and the third high-frequency feature map.

In an exemplary embodiment of the present disclosure, the second octave convolution unit 15201 is specifically configured to: perform a first convolution process on the input high-frequency feature map to obtain a second high-frequency feature map, perform an up-sampling convolution process on the input low-frequency feature map to obtain a second low-frequency feature map; acquire a third high-frequency feature map according to the second high-frequency feature map and the second low-frequency feature map, and perform a high-frequency feature extraction process on the third high-frequency feature map to obtain a fourth high-frequency feature map; short-circuit the input high-frequency feature map to obtain the fifth high-frequency feature map, and acquire the target high-frequency feature map according to the fourth high-frequency feature map and the fifth high-frequency feature map; perform a second convolution process on the input low-frequency feature map to obtain the third low-frequency feature map, and perform a down-sampling convolution process on the input high-frequency feature map to obtain a sixth high-frequency feature map; acquire a fourth low-frequency feature map based on the third low-frequency feature map and the sixth high-frequency feature map, and perform a low-frequency feature extraction process on the fourth low-frequency feature map to obtain a fifth low-frequency feature map; short-circuit the input low-frequency feature map to obtain a sixth low-frequency feature map, and acquire the target low-frequency feature map based on the fifth low-frequency feature map and the sixth low-frequency feature map.

In an exemplary embodiment of the present disclosure, the attention unit 15202 is specifically configured to: encode each channel of the target high-frequency feature map and the target low-frequency feature map along the horizontal direction to obtain a first direction perceptual map, and encode each channel of the target high-frequency feature map and the target low-frequency feature map output by the convolution module along the vertical direction to obtain a second directional perceptual map; connect the first directional perceptual map and the second directional perceptual map to obtain a third directional perceptual map, and perform a first convolution transformation process on the third directional perceptual map to obtain an intermediate feature mapping diagram; divide the intermediate feature mapping diagram into a first tensor and a second tensor along the spatial dimension, and perform a second convolution transformation process on the first tensor and the second tensor; expand the first tensor and the second tensor after the second convolution transformation process to obtain the target high-frequency feature map with an adjusted feature weight and the target low-frequency feature map with an adjusted feature weight.

In an exemplary embodiment of the present disclosure, the n-th level convolution module is also used to perform a 2⁽ⁿ⁺¹⁾x down-sampling process on the input first high-frequency feature map and first low-frequency feature map.

The feature merging module 1530 is specifically configured to: perform a 2⁽ⁿ⁺¹⁾x up-sampling process on the target high-frequency feature map and the target low-frequency feature map output by the attention unit included in the n-th level convolution module; and merge, in corresponding dimensions, and connect, in corresponding channel numbers, the M pairs of target high-frequency feature map and target low-frequency feature map after the up-sampling process to obtain the target feature map of the target image.

The specific details of each module and component in the above text recognition apparatus and text recognition system have been described in detail in the corresponding text recognition method, so they will not be described again here.

It should be noted that although several modules or components of the device for action execution are mentioned in the above detailed description, this division is not mandatory. In fact, according to embodiments of the present disclosure, the features and functions of two or more modules or components described above may be embodied in one module or unit. Conversely, the features and functions of one module or unit described above may be further divided into being embodied by multiple modules or units.

Various component embodiments of the present disclosure may be implemented in hardware, or in software modules running on one or more processors, or in a combination thereof.

In an exemplary embodiment of the present disclosure, an electronic device is further provided, including: a processor; and a memory configured to store instructions executable by the processor. The processor is configured to perform the method described in any one of the exemplary embodiments.

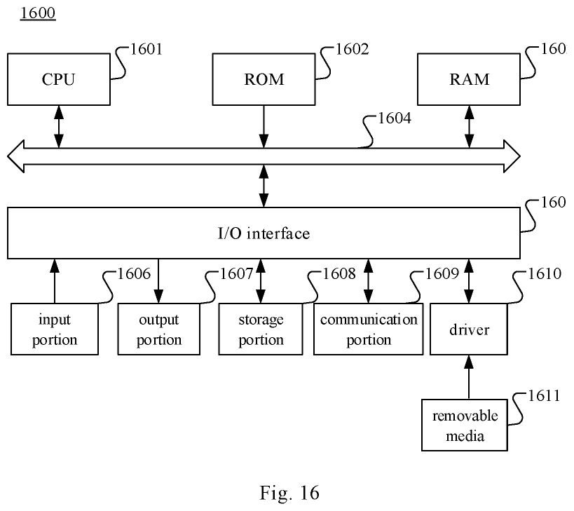

FIG. 16 shows a schematic structural diagram of a computer system used to implement an electronic device according to an embodiment of the present disclosure. It should be noted that the computer system 1600 of the electronic device shown in FIG. 16 is only an example, and should not impose any restrictions on the functions and scope of use of the embodiments of the present disclosure.

As shown in FIG. 16, the computer system 1600 includes a central processing unit 1601 that can perform various appropriate operations and processes according to programs stored in the read-only memory 1602 or loaded from the storage portion 1608 into the random access memory 1603. In the random access memory 1603, various programs and data required for system operation are also stored. The central processing unit 1601, the read-only memory 1602, and the random access memory 1603 are connected to each other through a bus 1604. Input/output interface 1605 is also connected to bus 1604.

The following components are connected to the input/output interface 1605: an input portion 1606 including a keyboard, a mouse, etc.; an output portion 1607 including a cathode ray tube (CRT), a liquid crystal display (LCD), speakers, etc.; a storage portion 1608 including a hard disk, etc.; and a communications portion 1609 including a network interface card such as a local area network (LAN) card, modem, etc. The communication portion 1609 performs communication processing via a network such as the Internet. Driver 1610 is also connected to input/output interface 1605 as needed. Removable media 1611, such as magnetic disks, optical disks, magneto-optical disks, semiconductor memories, etc., are installed on the driver 1610 as needed, so that a computer program read therefrom is installed into the storage portion 1608 as needed.

In particular, according to embodiments of the present disclosure, the processes described above with reference to the flowcharts may be implemented as computer software programs. For example, embodiments of the present disclosure include a computer program product including a computer program carried on a computer-readable medium, the computer program containing program codes for performing the method illustrated in the flowchart. In such embodiments, the computer program may be downloaded and installed from the network via communications portion 1609, and/or installed from removable media 1611. When the computer program is executed by the central processor 1601, various functions defined in the device of the present application are executed.

In an exemplary embodiment of the present disclosure, a non-volatile computer-readable storage medium is also provided, on which a computer program is stored. When the computer program is executed by a computer, the computer performs any of the methods described above.

It should be noted that the non-volatile computer-readable storage medium shown in the present disclosure may be, for example, but not limited to, an electrical, magnetic, optical, electromagnetic, infrared, or semiconductor system, device, or apparatus, or combination of any of the above. More specific examples of computer readable storage media may include, but are not limited to: electrical connections having one or more wires, portable computer disks, hard drives, random access memory, read only memory, erasable programmable read only memory (EPROM) or flash memory), optical fiber, portable compact disk read-only memory (CD-ROM), optical storage device, magnetic storage device, or any suitable combination of the above. In the present disclosure, a computer-readable storage medium may be any tangible medium that contains or stores a program for use by or in connection with an instruction execution system, apparatus, or device. In the present disclosure, a computer-readable signal medium may include a data signal propagated in baseband or as part of a carrier wave, carrying computer-readable program codes therein. Such propagated data signals may take many forms, including but not limited to electromagnetic signals, optical signals, or any suitable combination of the above. A computer-readable signal medium may also be any computer-readable medium other than a computer-readable storage medium that can send, propagate, or transmit a program for use by or in connection with an instruction execution system, apparatus, or device. Program codes embodied on a computer-readable medium may be transmitted using any suitable medium, including but not limited to: wireless, wire, optical cable, radio frequency, etc., or any suitable combination of the foregoing.

Other embodiments of the present disclosure will be readily apparent to those skilled in the art from consideration of the specification and practice of the contents disclosed herein. This application is intended to cover any variations, uses, or adaptations of the present disclosure that follow the general principles of the present disclosure and include common knowledge or customary technical means in the technical field that are not disclosed in the present disclosure. It is intended that the specification and examples be considered as exemplary only.

1. A text recognition method, comprising:
acquiring a first high-frequency feature map and a first low-frequency feature map of a target image;
performing an M-level convolution process on the first high-frequency feature map and the first low-frequency feature map by M cascaded convolution modules to obtain M pairs of target high-frequency feature map and target low-frequency feature map of the target image, where M is a positive integer;
merging the M pairs of target high-frequency feature map and target low-frequency feature map to obtain a target feature map of the target image;
determining a probability map and a threshold map of the target image based on the target feature map, and calculating a binarization map of the target image based on the probability map and the threshold map; and
determining a text area in the target image based on the binarization map, and recognizing text information in the text area.

2. The text recognition method according to claim 1, wherein
the convolution module performs a convolution process on the first high-frequency feature map and the first low-frequency feature map, and the convolution process comprises:
performing a first convolution process on the input first high-frequency feature map to obtain a second high-frequency feature map, and performing an up-sampling convolution process on the input first low-frequency feature map to obtain a second low-frequency feature map;
acquiring the target high-frequency feature map based on the second high-frequency feature map and the second low-frequency feature map;
performing a second convolution process on the input first low-frequency feature map to obtain a third low-frequency feature map, and performing a down-sampling convolution process on the input first high-frequency feature map to obtain a third high-frequency feature map; and
acquiring the target low-frequency feature map based on the third low-frequency feature map and the third high-frequency feature map.

3. The text recognition method according to claim 1, wherein
the convolution module performs a convolution process on the first high-frequency feature map and the first low-frequency feature map, and the convolution process comprises:
performing a first convolution process on the input first high-frequency feature map to obtain a second high-frequency feature map, and performing an up-sampling convolution process on the input first low-frequency feature map to obtain a second low-frequency feature map;
acquiring a third high-frequency feature map based on the second high-frequency feature map and the second low-frequency feature map, and performing a high-frequency feature extraction process on the third high-frequency feature map to obtain a fourth high-frequency feature map;
short-circuiting the first high-frequency feature map to obtain a fifth high-frequency feature map, and acquiring the target high-frequency feature map based on the fourth high-frequency feature map and the fifth high-frequency feature map;
performing a second convolution process on the input first low-frequency feature map to obtain a third low-frequency feature map, and performing a down-sampling convolution process on the input first high-frequency feature map to obtain a sixth high-frequency feature map;
acquiring a fourth low-frequency feature map based on the third low-frequency feature map and the sixth high-frequency feature map, and performing a low-frequency feature extraction process on the fourth low-frequency feature map to obtain a fifth low-frequency feature map; and
short-circuiting the first low-frequency feature map to obtain a sixth low-frequency feature map, and acquiring the target low-frequency feature map based on the fifth low-frequency feature map and the sixth low-frequency feature map.

4. The text recognition method according to claim 3, wherein
the high-frequency feature extraction process performed on the third high-frequency feature map comprises: performing a third convolution process on the third high-frequency feature map; and
the low-frequency feature extraction process performed on the fourth low-frequency feature map comprises: performing a fourth convolution process on the fourth low-frequency feature map.

5. The text recognition method according to claim 1, wherein
each convolution module comprises an attention unit; and
the method further comprises:
adjusting a feature weight output by the convolution module through the attention unit.

6. The text recognition method according to claim 5, wherein
the adjusting of the feature weight output by the convolution module comprises:
encoding each channel of the target high-frequency feature map and the target low-frequency feature map output by the convolution module along a horizontal direction to obtain a first direction perceptual map, and encoding each channel of the target high-frequency feature map and the target low-frequency feature map output by the convolution module along a vertical direction to obtain a second direction perceptual map;
connecting the first directional perceptual map and the second directional perceptual map to obtain a third directional perceptual map, and performing a first convolution transformation process on the third directional perceptual map to obtain an intermediate feature mapping diagram;
dividing the intermediate feature mapping diagram into a first tensor and a second tensor along a spatial dimension, and performing a second convolution transformation process on the first tensor and the second tensor; and
expanding the first tensor and the second tensor after the second convolution transformation process to obtain a target high-frequency feature map with an adjusted feature weight and a target low-frequency feature map with an adjusted feature weight.

7. The text recognition method according to claim 6, wherein
an n-th level convolution module is further configured to perform a 2⁽ⁿ⁺¹⁾x down-sampling process on the input first high-frequency feature map and first low-frequency feature map; and
the merging of the M pairs of target high-frequency feature map and target low-frequency feature map to obtain the target feature map of the target image, comprises:
performing a 2⁽ⁿ⁺¹⁾x up-sampling process on the target high-frequency feature map and the target low-frequency feature map output by the attention unit comprised in the n-th level convolution module; and
merging, in corresponding dimensions, and connecting, in corresponding channel numbers, the M pairs of target high-frequency feature map and target low-frequency feature map after the up-sampling process to obtain the target feature map of the target image.

8. The text recognition method according to claim 7, wherein M is 4.

9. The text recognition method according to claim 5, wherein
the determining of the probability map and the threshold map of the target image based on the target feature map, and the calculating of the binarization map of the target image based on the probability map and the threshold map, comprise:
predicting a probability that each pixel in the target image is text based on the target feature map to obtain the probability map of the target image;
predicting a binary result that each pixel in the target image is text based on the target feature map to obtain the threshold map of the target image; and
performing an adaptive learning process by using a differentiable binarization function in combination with the probability map and the threshold map to obtain a best adaptive threshold, and acquiring the binarization map of the target image based on the best adaptive threshold and the probability map.

10. The text recognition method according to claim 5, wherein the method further comprises:
predicting definition information of the target image based on the target high-frequency feature map and the target low-frequency feature map output by the attention unit comprised in an M-th level convolution module; and/or
predicting angle offset information of the target image based on the target high-frequency feature map and the target low-frequency feature map output by the attention unit comprised in the M-th level convolution module.

11. The text recognition method according to claim 1, wherein the method further comprises:
predicting a language in which the target image contains text based on the target feature map; and
the recognizing of the text information in the text area comprises:
determining a corresponding text recognition model according to the language in which the target image contains the text to recognize the text information in the text area.

12-18. (canceled)

19. A non-volatile computer-readable storage medium having a computer program stored thereon, wherein the computer program is configured to perform a text recognition method under a condition of the computer program being executed by a processor, wherein the text recognition method comprises:
acquiring a first high-frequency feature map and a first low-frequency feature map of a target image;
performing an M-level convolution process on the first high-frequency feature map and the first low-frequency feature map by M cascaded convolution modules to obtain M pairs of target high-frequency feature map and target low-frequency feature map of the target image, where M is a positive integer;
merging the M pairs of target high-frequency feature map and target low-frequency feature map to obtain a target feature map of the target image;
determining a probability map and a threshold map of the target image based on the target feature map, and calculating a binarization map of the target image based on the probability map and the threshold map; and
determining a text area in the target image based on the binarization map, and recognizing text information in the text area.

20. An electronic device, comprising:
a processor; and
a memory, configured to store executable instructions for the processor, wherein
the processor is configured to perform a text recognition method under a condition of the processor executing the executable instructions, wherein the text recognition method comprises:
acquiring a first high-frequency feature map and a first low-frequency feature map of a target image;
performing an M-level convolution process on the first high-frequency feature map and the first low-frequency feature map by M cascaded convolution modules to obtain M pairs of target high-frequency feature map and target low-frequency feature map of the target image, where M is a positive integer;
merging the M pairs of target high-frequency feature map and target low-frequency feature map to obtain a target feature map of the target image;
determining a probability map and a threshold map of the target image based on the target feature map, and calculating a binarization map of the target image based on the probability map and the threshold map; and
determining a text area in the target image based on the binarization map, and recognizing text information in the text area.

21. The electronic device according to claim 20, wherein
the convolution module performs a convolution process on the first high-frequency feature map and the first low-frequency feature map, and the convolution process comprises:
performing a first convolution process on the input first high-frequency feature map to obtain a second high-frequency feature map, and performing an up-sampling convolution process on the input first low-frequency feature map to obtain a second low-frequency feature map;
acquiring the target high-frequency feature map based on the second high-frequency feature map and the second low-frequency feature map;
performing a second convolution process on the input first low-frequency feature map to obtain a third low-frequency feature map, and performing a down-sampling convolution process on the input first high-frequency feature map to obtain a third high-frequency feature map; and
acquiring the target low-frequency feature map based on the third low-frequency feature map and the third high-frequency feature map.

22. The electronic device according to claim 20, wherein
the convolution module performs a convolution process on the first high-frequency feature map and the first low-frequency feature map, and the convolution process comprises:
performing a first convolution process on the input first high-frequency feature map to obtain a second high-frequency feature map, and performing an up-sampling convolution process on the input first low-frequency feature map to obtain a second low-frequency feature map;
acquiring a third high-frequency feature map based on the second high-frequency feature map and the second low-frequency feature map, and performing a high-frequency feature extraction process on the third high-frequency feature map to obtain a fourth high-frequency feature map;
short-circuiting the first high-frequency feature map to obtain a fifth high-frequency feature map, and acquiring the target high-frequency feature map based on the fourth high-frequency feature map and the fifth high-frequency feature map;
performing a second convolution process on the input first low-frequency feature map to obtain a third low-frequency feature map, and performing a down-sampling convolution process on the input first high-frequency feature map to obtain a sixth high-frequency feature map;
acquiring a fourth low-frequency feature map based on the third low-frequency feature map and the sixth high-frequency feature map, and performing a low-frequency feature extraction process on the fourth low-frequency feature map to obtain a fifth low-frequency feature map; and
short-circuiting the first low-frequency feature map to obtain a sixth low-frequency feature map, and acquiring the target low-frequency feature map based on the fifth low-frequency feature map and the sixth low-frequency feature map.

23. The electronic device according to claim 22, wherein
the high-frequency feature extraction process performed on the third high-frequency feature map comprises: performing a third convolution process on the third high-frequency feature map; and
the low-frequency feature extraction process performed on the fourth low-frequency feature map comprises: performing a fourth convolution process on the fourth low-frequency feature map.

24. The electronic device according to claim 20, wherein
each convolution module comprises an attention unit; and
the method further comprises:
adjusting a feature weight output by the convolution module through the attention unit.

25. The electronic device according to claim 24, wherein
the adjusting of the feature weight output by the convolution module comprises:
encoding each channel of the target high-frequency feature map and the target low-frequency feature map output by the convolution module along a horizontal direction to obtain a first direction perceptual map, and encoding each channel of the target high-frequency feature map and the target low-frequency feature map output by the convolution module along a vertical direction to obtain a second direction perceptual map;
connecting the first directional perceptual map and the second directional perceptual map to obtain a third directional perceptual map, and performing a first convolution transformation process on the third directional perceptual map to obtain an intermediate feature mapping diagram;
dividing the intermediate feature mapping diagram into a first tensor and a second tensor along a spatial dimension, and performing a second convolution transformation process on the first tensor and the second tensor; and
expanding the first tensor and the second tensor after the second convolution transformation process to obtain a target high-frequency feature map with an adjusted feature weight and a target low-frequency feature map with an adjusted feature weight.

26. The electronic device according to claim 24, wherein
the determining of the probability map and the threshold map of the target image based on the target feature map, and the calculating of the binarization map of the target image based on the probability map and the threshold map, comprise:
predicting a probability that each pixel in the target image is text based on the target feature map to obtain the probability map of the target image;
predicting a binary result that each pixel in the target image is text based on the target feature map to obtain the threshold map of the target image; and
performing an adaptive learning process by using a differentiable binarization function in combination with the probability map and the threshold map to obtain a best adaptive threshold, and acquiring the binarization map of the target image based on the best adaptive threshold and the probability map.

27. The electronic device according to claim 24, wherein the method further comprises:
predicting definition information of the target image based on the target high-frequency feature map and the target low-frequency feature map output by the attention unit comprised in an M-th level convolution module; and/or
predicting angle offset information of the target image based on the target high-frequency feature map and the target low-frequency feature map output by the attention unit comprised in the M-th level convolution module.
